(19) United States
(12) Patent Application Publication
(10) Pub. No.: US 2004/0146118 A1
(43) Pub. Date: Jul. 29, 2004

(54) Method and apparatus for RF carrier suppression in a multi-modulator transmitter

(76) Inventors: Sumit A. Talwalkar, Plantation, FL (US); John R. Melton, Coral Springs, FL (US); Mahibur Rahman, Lake Worth, FL (US); Vance Peterson, Boca Raton, FL (US)

Correspondence Address: David D. Bahler, FULBRIGHT & JAWORSKI., L.L.P., Suite 2400, 600 Congress Avenue, Austin, TX, 78701, US

(21) Appl. No.: 10/349,638

(22) Filed: Jan. 23, 2003

(51) Int. Cl. H04L 27/36

(52) U.S. Cl. 375/298

(57) ABSTRACT

A method for suppressing a carrier in a quadrature modulator includes applying a first set of four correction signal pairs to a quadrature modulator and detecting a first set of four output signals, identifying a first optimum correction signal pair among the first set of four correction signal pairs, and applying the first optimum correction signal pair to the quadrature modulator for suppressing a carrier. An apparatus for suppressing a carrier in a quadrature modulator includes an amplifier, a radio frequency detector coupled to the amplifier, an analog-to-digital converter coupled to the radio frequency detector, a correction circuit coupled to the analog-to-digital converter; the correction circuit performing a search algorithm during a training period and determining a pair of channel correction values for suppressing a carrier; and a pair of summers coupled to the correction circuit.

### BACKGROUND OF THE INVENTION

1. Field of the Invention

The invention relates generally to the field of communications. More particularly, the invention relates to radio frequency (RF) communications.

2. Discussion of the Related Art

Quadrature modulation techniques enable two independent signals to be combined at a transmitter, transmitted on the same transmission band, and separated at a receiver. The principle of quadrature modulation is that two separate signals, I and Q (In-phase and Quadrature phase), are modulated by using the same carrier wave frequency, but the carrier wave of signal Q is 90° out of phase relative to the carrier wave of signal I. After modulation, the resulting signals are summed and transmitted. Because of the phase difference, the I and Q signals can be separated from each other when the summed signal is demodulated at the receiver.

Unfortunately, in practical applications, quadrature modulator circuit elements in the baseband (I and Q) channels may present electrical mismatch and produce DC offsets. Since the baseband paths are DC coupled, all individual DC offset errors may add up and produce a combined effect in the form a carrier feed-through at the modulator output.

Moreover, multi-modulation transmitters may yield different DC offset errors according to which modulation path is being used. These transmitters may simultaneously support a number of radio frequency communication protocols such as, for example: global system for mobile communications (GSM), enhanced data-rate for GSM evolution (EDGE), and wideband code division multiple access (WCDMA).

Until now, the requirements of providing a method and apparatus for suppressing carrier feed-through in a multi-modulator platform by digitally correcting independent I and Q channel DC offsets at baseband using a single RF detector and a single analog-to-digital converter circuit have not been met.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same or similar elements. The invention may be better understood by reference to one or more of these drawings in combination with the description presented herein. It should be noted that the features illustrated in the drawings are not necessarily drawn to scale.

FIG. 1 is a block diagram of a carrier suppression system for a single transmitter, representing an embodiment of the invention.

FIG. 2 is a block diagram of a carrier suppression system for a multi-modulator transmitter, representing another embodiment of the invention.

FIG. 3 is a flowchart of an unrotated carrier suppression method, representing an embodiment of the invention.

FIG. 4 is a diagram of an unrotated carrier suppression iteration, illustrating an embodiment of the invention.

FIG. 5 is a flowchart of a rotated carrier suppression method, representing an embodiment of the invention.

FIG. 6 is a diagram of a rotated carrier suppression iteration, illustrating an embodiment of the invention.

FIG. 7 is a flowchart of a hybrid carrier suppression method, representing an embodiment of the invention.

FIG. 8 is a diagram of a hybrid carrier suppression iteration, illustrating an embodiment of the invention.

### DETAILED DESCRIPTION

The invention and the various features and advantageous details thereof are explained more fully with reference to the nonlimiting embodiments that are illustrated in the accompanying drawings and detailed in the following description. It should be understood that the detailed description and the specific examples, while indicating specific embodiments of the invention, are given by way of illustration only and not by way of limitation. Various substitutions, modifications, additions and/or rearrangements within the spirit and/or scope of the underlying inventive concept will become apparent to those of ordinary skill in the art from this disclosure.

According to an aspect of the invention, a method for suppressing a carrier in a quadrature modulator includes applying a first set of four correction signal pairs to a quadrature modulator and detecting a first set of four output signals, identifying a first optimum correction signal pair among the first set of four correction signal pairs, and applying the first optimum correction signal pair to the quadrature modulator for suppressing a carrier.

According to another aspect of the invention, an apparatus for suppressing a carrier in a quadrature modulator includes an amplifier, a radio frequency detector coupled to the amplifier, an analog-to-digital converter coupled to the radio frequency detector, a correction circuit coupled to the analog-to-digital converter; the correction circuit performing a search algorithm during a training period and determining a pair of channel correction values for suppressing a carrier; and a pair of summers coupled to the correction circuit.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

The invention may include a method and apparatus for suppressing a carrier in a quadrature modulator, in a multi-modulator, or the like. In one embodiment, the invention may include a carrier suppression method and apparatus that use magnitude-only measurements to generate I and Q channel corrections to compensate for DC offsets in the baseband circuit. In another embodiment, the invention may include a carrier suppression method and apparatus for operating in the presence of gain imbalances and/or phase errors.

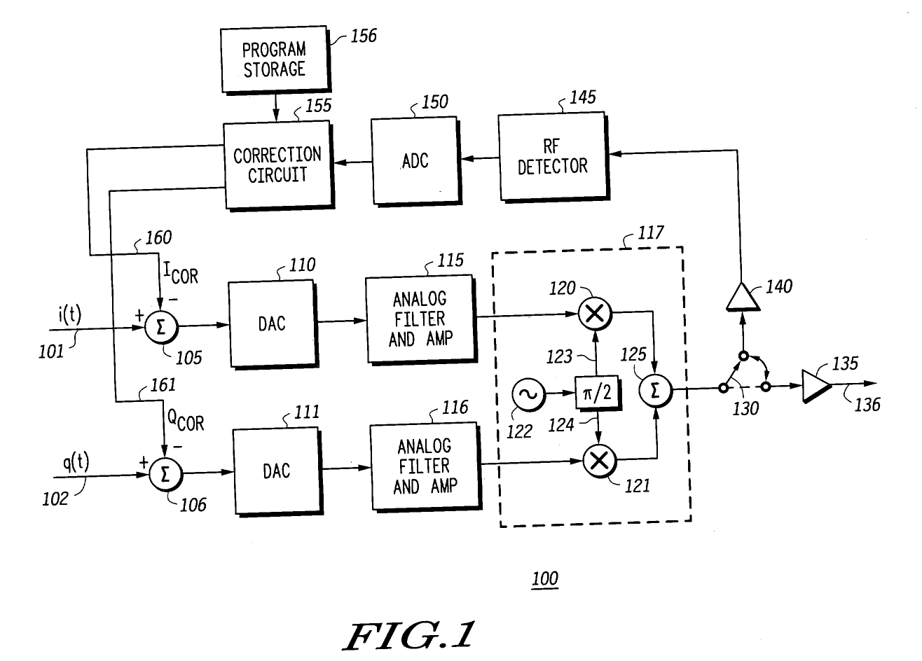

Referring to FIG. 1, a block diagram of a carrier suppression system 100 for a single transmitter is depicted according to one exemplary embodiment of the invention. An in-phase channel I 101 is coupled to the positive input of a first summer 105. The output of the first summer 105 is coupled to a first digital-to-analog converter 110. The first digital-to-analog converter 110 is coupled to a first analog filter and amplifier circuit 115, and the first analog filter and amplifier circuit 115 is coupled to a first mixer 120 of a quadrature modulator 117, where it is mixed with a first carrier signal 123 from a local oscillator 122. A quadrature phase channel Q 102 is coupled to the positive input of a second summer 106. The output of the second summer 106 is coupled to a second digital-to-analog converter 111. The second digital-to-analog converter 111 is coupled to a second analog filter and amplifier circuit 116, and the second analog filter and amplifier circuit 116 is coupled to a second mixer 121 of the quadrature modulator 117, where it is mixed with a second carrier signal 124 from the local oscillator 122. The first and second carrier signals 123, 124 are 90° out of phase with respect to each other.

The first and second mixers 120, 121 are coupled to the inputs of a summer 125, and the output of the summer 125 is coupled to a switch 130. During a transmission operation, the switch 130 may be in a normal position, coupling the output of the summer 125 to an output amplifier 135, which produces an amplified signal 136. The operation of the system 100 with the switch 130 in the normal position as described above is well known to one of ordinary skill in the art.

When the switch 130 is in a training position, it couples the output of the summer 125 to a voltage controlled amplifier 140. The voltage controlled amplifier 140 is coupled to an RF detector circuit 145. The RF detector circuit 145 is coupled to an analog-to-digital converter circuit 150, and the analog-to-digital converter circuit 150 is coupled to a correction circuit 155. A program storage media 156 is coupled to the correction circuit 155. The correction circuit 155 may output an in-phase correction signal (I_{COR}) 160 into the negative input of the first summer 105 and the quadrature-phase correction signal (Q_{COR}) 161 into the negative input of the second summer 106.

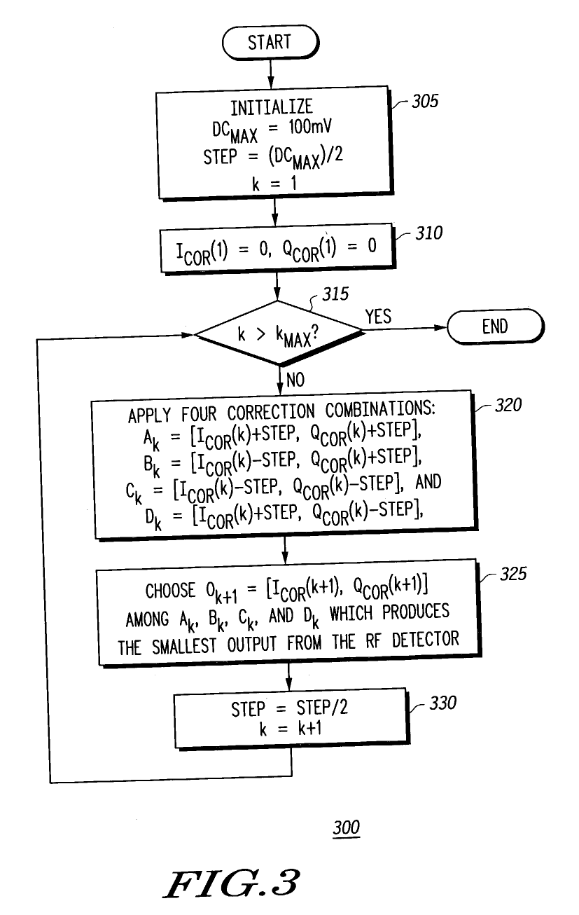

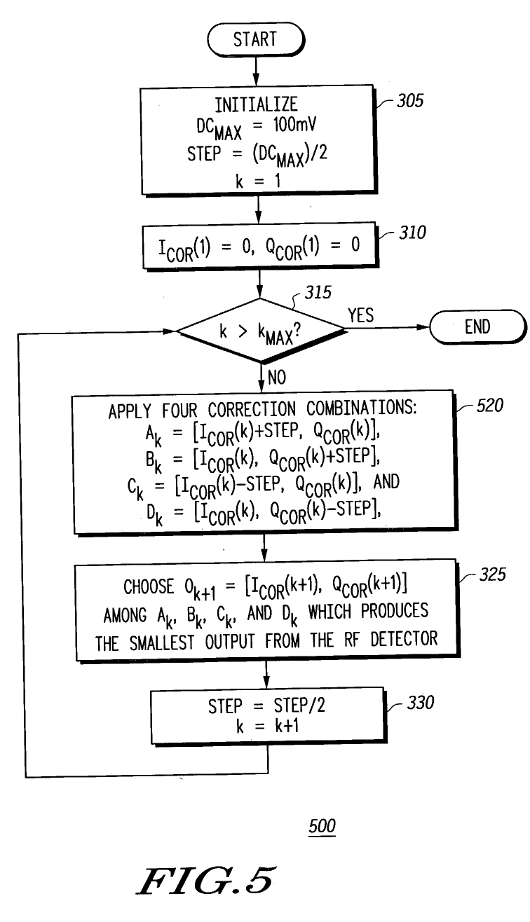

During a training period, the in-phase and quadrature phase input signals 101, 102 are held at a zero value and the switch 130 is in the training position, causing the output of the modulator 117 to follow the feedback path. The voltage controlled amplifier 140 may simulate the normal position electrical load presented by the output amplifier 135 to the modulator 117. The RF detector 145 detects the output of the voltage controlled amplifier 140, and the analog-to-digital converter 150 converts the output of the RF detector 145 into a digital signal. The correction circuit 155 receives the digital signal and performs a method such as detailed in FIGS. 3, 5, or 7.

At the end of the training period, in-phase and quadrature phase correction signals 160, 161 may be determined and the switch 130 may return to a normal position. Then, the system 100 may resume its normal operation, and the in-phase and quadrature phase correction signals 160, 161 may compensate for baseband DC offsets, thereby suppressing an RF carrier. In one embodiment, the invention may include performing a training function periodically.

In practice, the carrier suppression system 100 may be implemented as an integrated circuit (IC). The correction circuit 155 may be a programmable circuit, such as, for example, a microprocessor or digital signal processor-based circuit, that operates in accordance with instructions stored in the program storage media 156. The program storage media 156 may be any type of readable memory including, for example, a magnetic or optical media such as a card, tape or disk, or a semiconductor memory such as a PROM or FLASH memory. The correction circuit 155 may be implemented in software, or the functions may be implemented by a hardware circuit, or by a combination of hardware and software.

When the correction circuit 155 is a programmable circuit, a program, such as that presented below and discussed in detail with reference to FIGS. 3, 5, and 7, is stored in the program storage media 156 to create an apparatus in accordance with the present invention that operates in accordance with the methods of the present invention. In the alternative, the correction circuit 155 may be hard-wired or may use predetermined data tables, or may be a combination of hard-wired and programmable circuitry.

In one embodiment, the invention may include a multi-modulator structure. Multi-modulators are used to efficiently support different modulation protocols due to the trade-offs among noise figures, inter-modulation requirements, and current drain among the various modulation paths. The invention may include a method and/or apparatus for suppressing a carrier in a multi-modulator system.

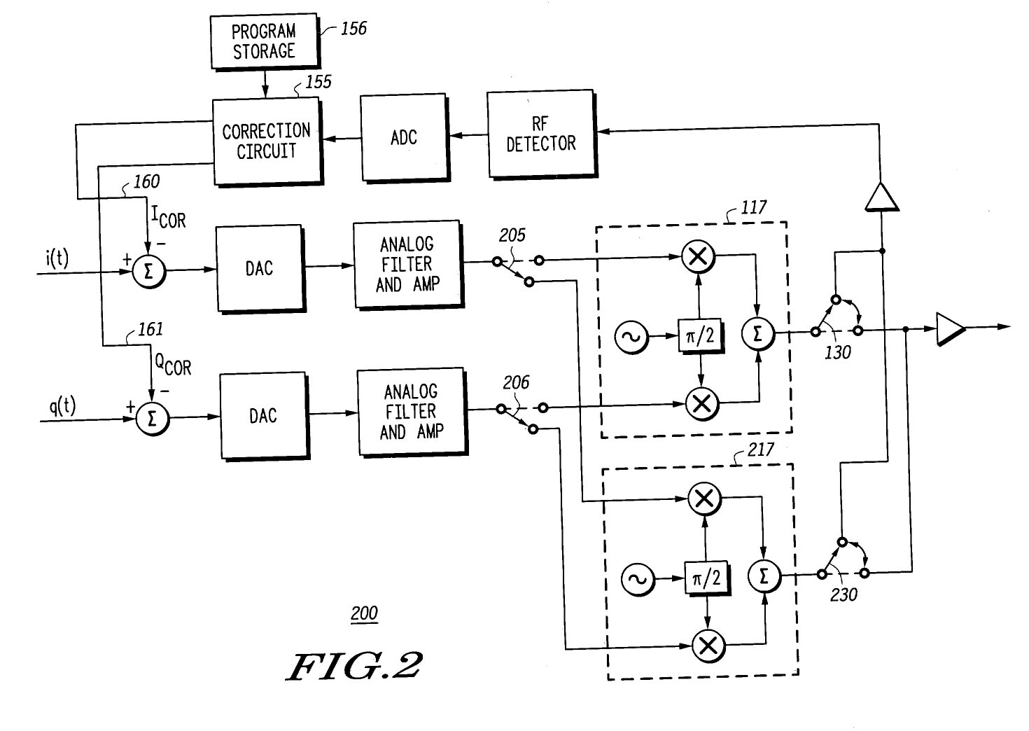

Referring to FIG. 2, a block diagram of a carrier suppression system for a multi-modulator transmitter 200 is depicted according to one exemplary embodiment of the invention. A first set of switches 205, 206 alternate operation between modulators 117 and 217. The modulators 117, 217 are coupled to a second set of switches 130, 230.

In one embodiment, when the transmitter 200 switches operation to a different modulator, a training sequence may be performed and the correction circuit 155 may output in-phase and quadrature phase correction signals 160, 161 to compensate for the new DC offset, thereby suppressing an RF carrier under the particular modulation path in use. In another embodiment, the transmitter 200 includes a plurality of modulators.

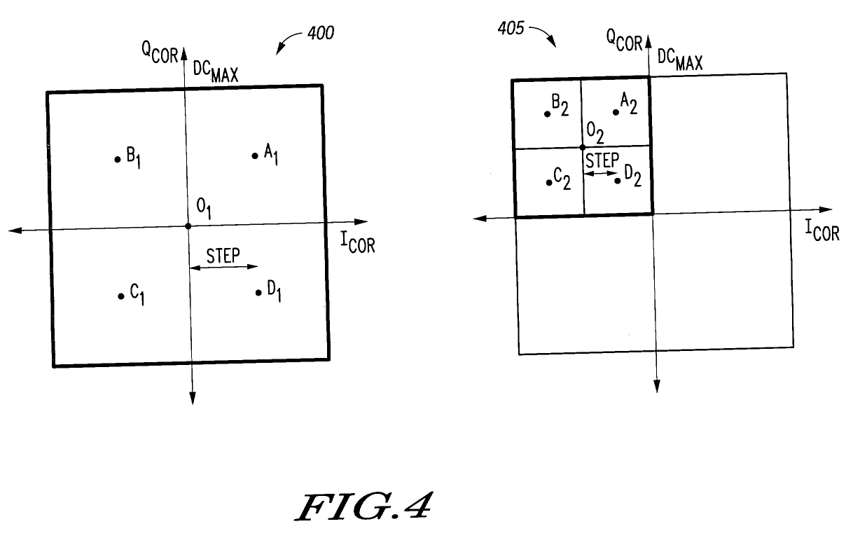

Referring to FIG. 3, a flowchart of an unrotated carrier suppression method 300 is depicted according to one exemplary embodiment of the invention. The unrotated carrier suppression method 300 may include a 2-dimensional binary search. The unrotated method 300 may be performed by the correction circuit 155 of the carrier suppression system detailed in FIGS. 1 and 2. Referring to FIG. 4, a diagram of an unrotated carrier suppression iteration is depicted illustrating an aspect of the invention detailed in FIG. 3. The horizontal axis is the in-phase correction signal I_{COR} and the vertical axis is quadrature-phase correction signal Q_{COR}.

Referring to FIGS. 3 and 4, the unrotated method 300 may determine a search area and apply a set of correction signal signal pairs (I_{COR}, Q_{COR}) to the in-phase and quadrature-phase channels of a modulator, while measuring the output of the modulator with an RF detector. Next, the unrotated method 300 may modify the search area in order to minimize the output of the modulator and repeat a searching process for a predetermined number of times from k=1 to k=k_{MAX}, where k is an index or a counting variable and k_{MAX} is the total number of iterations. In one embodiment, the amplitude of a maximum DC error (DC_{MAX}) may determine an initial search area 400. The initial search area 400 may be a square of side equal to 2DC_{MAX} centered at an origin Ok. The initial search area 400 may be divided into four quadrants, and four correction signal pairs may each correspond to the X and Y coordinates of the center of a search area quadrant.

In an initialization step 305, a step variable is defined as a function of DC_{MAX}, and k is set to 1. In one embodiment, DC_{MAX} equals approximately 100 mV, and the step variable value is set to

$$\frac{D {C}_{MAX}}{2} .$$

In step 310, I_{COR} and Q_{COR} are set to zero, that is, I_{COR}(k=1)=Q_{COR}(k=1)=0, and control passes to step 315. If k is greater than a predetermined value (k>k_{MAX}), the method ends. Otherwise, control passes to step 320. In one embodiment, k_{MAX}=10.

In step 320, four correction signal combination pairs (Aₖ, Bₖ, Cₖ and Dₖ) are sequentially applied to the I and Q channels as I_{COR} and Q_{COR} signals, and four outputs are detected. Each correction signal pair has X and Y coordinates in the form [X, Y]. The X coordinate value is applied to the I channel via I_{COR} and the Y coordinate value is applied to the Q channel via Q_{COR} simultaneously. In one embodiment, the correction signal pairs may be expressed by:

Aₖ=[I_{COR}(k)+step, Q_{COR}(k)+step];

Bₖ=[I_{COR}(k)−step, Q_{COR}(k)+step];

Cₖ=[I_{COR}(k)+step, Q_{COR}(k)−step]; and

Dₖ=[I_{COR}(k)+step, Q_{COR}(k)−step].

In step 325, a new search area 405 is chosen. The new search area 405 is centered at the X and Y coordinates of the correction signal pair which yielded the smallest detected RF output. For example, if the combination pair corresponding to B₁ resulted in the smallest output, then, for the next iteration, the new search area 405 is centered at O₂=B₁=[I_{COR}(1)−step, Q_{COR}(1)+step]. Next, in step 330, the step variable is divided by two

$$( step = \frac{D {C}_{MAX}}{4} )$$

and k is incremented by one and control returns to step 315.

The unrotated method 300 may search for the best quadrant of the search area at every iteration, providing a fast convergence by reducing the search area by a factor of 4 at every iteration. Thus, each iteration may add a binary digit of precision to each of the correction values I_{COR}, Q_{COR}. After the last iteration of the unrotated method 300, the X and Y coordinate values corresponding to the correction signal pair that yields the smallest RF output are selected as the optimum I_{COR} and Q_{COR} signals, respectively.

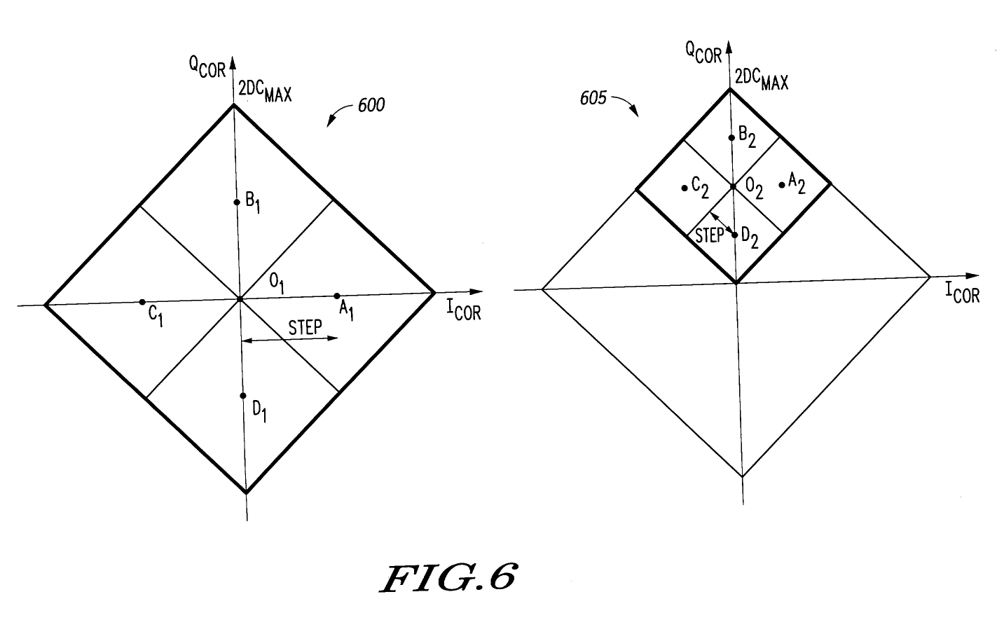

Referring to FIG. 5, a flowchart of a rotated carrier suppression method 500 is depicted according to one exemplary embodiment of the invention. The rotated method 500 may be performed by the correction circuit 155 of the carrier suppression system detailed in FIGS. 1 and 2. Referring to FIG. 6, a diagram of a rotated carrier suppression iteration is depicted illustrating an aspect of the invention detailed in FIG. 5. The horizontal axis is I_{COR} and the vertical axis is Q_{COR}.

Referring to FIGS. 5 and 6, the rotated method 500 may determine optimum I_{COR} and Q_{COR} signal in the presence of I-Q gain imbalance and/or local oscillator phase error. In the presence of gain imbalance and/or phase error, RF carrier amplitude contour lines may change from circles to ellipses with their axes rotated by 45°. Thus, rotated search areas 600, 605 may be aligned with the contour lines of the RF detector output.

The rotated method 500 is similar to the unrotated method 300 detailed in FIG. 3. In step 520, the four correction signal combination pairs (Aₖ, Bₖ, Cₖ and Dₖ), which are sequentially applied to the in-phase and quadrature phase channels, may be expressed by:

Aₖ=[I_{COR}(k)+step, Q_{COR}(k)];

Bₖ=[I_{COR}(k), Q_{COR}(k)+step];

Cₖ=[I_{COR}(k)−step, Q_{COR}(k)]; and

Dₖ=[I_{COR}(k), Q_{COR}(k)−step].

The rotated method 500 may search for the best quadrant of the rotated search area and reducing the area by a factor of 4 at every iteration. Thus, each iteration may add a binary digit of precision to each of the correction values I_{COR}, Q_{COR}. After the last iteration of the rotated method 500, the X and Y coordinate values corresponding to the correction signal pair that yields the smallest RF output are selected as the optimum I_{COR} and Q_{COR} signals, respectively.

In one embodiment, the invention may include using a hybrid search method as a combination of methods 300 and 500 detailed in FIGS. 3 and 5 for determining optimal values for I_{COR} and Q_{COR}. For example, the unrotated search method 300 may be performed during the first k₁ iterations, where k₁ is a first counting variable, and the rotated search method 500 may be used for the remaining iterations.

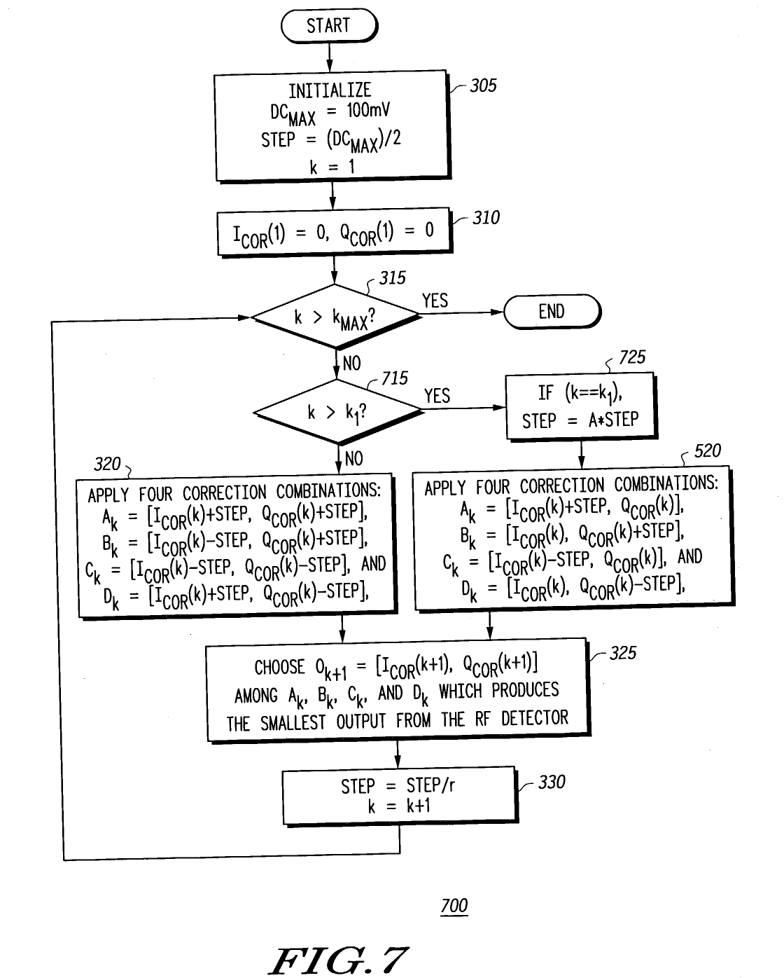

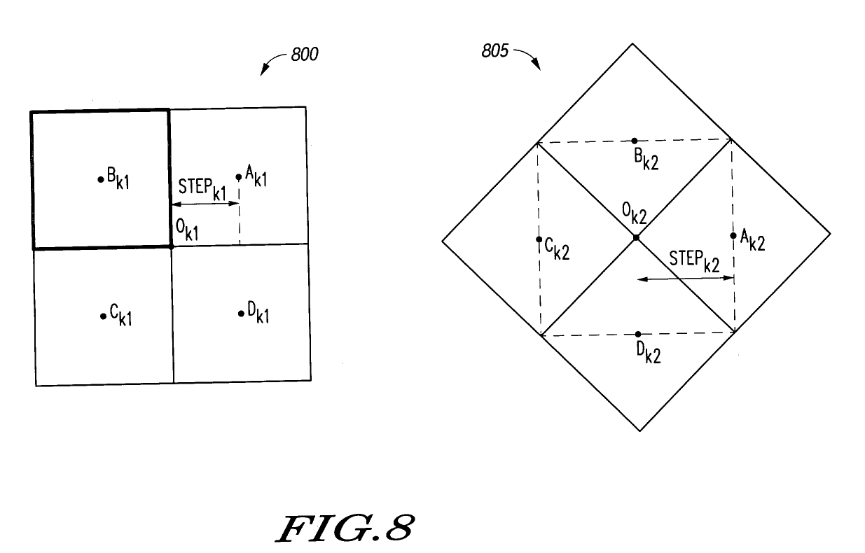

Referring to FIG. 7, a flowchart of a hybrid carrier suppression method 700 is depicted according to one exemplary embodiment of the invention. The hybrid method 500 may be performed by the correction circuit 155 of the carrier suppression system 100 detailed in FIGS. 1 and 2. Referring to FIG. 8, a diagram of a hybrid carrier suppression iteration is depicted illustrating an aspect of the invention detailed in FIG. 7. The horizontal axis is I_{COR} and the vertical axis is Q_{COR}.

In step 715, if the current iteration index (k) is less than or equal to a switching index (k₁), control passes to step 320 and the unrotated search method 300 is performed. Otherwise control passes to step 725 and the rotated search method 500 is performed until k>k_{MAX}. In step 725, the value of the step variable is multiplied by a value A if the first iteration of the rotated method is being performed, that is, k=k₁. In one embodiment, A is a number greater or equal to 2.

In another embodiment, the step variable is divided by a number r in step 330, where r is greater than 1 and lesser than or equal to 2. A variable step ratio (step/r) may be used to slower the search area reduction rate, thereby increasing accuracy. As one of ordinary skill in the art will recognize in light of this disclosure, there may be a trade-off between acquisition time and accuracy.

In the example of FIG. 7, Bₖ (from step 320) is the last chosen unrotated quadrant of the search area 800. Thus, in the following iteration (k₂=k₁+1), a first rotated search area 805 is defined. In order for the rotated search area 805 to include the unrotated chosen quadrant of search area 800 the rotated search area 805 is increased by a factor of A at the beginning of the (k₁+1)^{th} iteration. After the last iteration of the hybrid method 700, the X and Y coordinate values corresponding to the correction signal pair that yields the smallest RF output are selected as the optimum I_{COR} and Q_{COR} signals, respectively.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term approximately, as used herein, is defined as at least close to a given value (e.g., preferably within 10% of, more preferably within 1% of, and most preferably within 0.1% of). The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method for suppressing a carrier in a quadrature modulator, comprising:
applying a first set of four correction signal pairs to a quadrature modulator and detecting a first set of four output signals;
identifying a first optimum correction signal pair among the first set of four correction signal pairs; and
applying the first optimum correction signal pair to the quadrature modulator for suppressing a carrier.

2. The method of claim 1, further comprising creating a first search area, the first search area having a first set of four search area quadrants.

3. The method of claim 2, wherein each of the first set of four correction signal pairs corresponds to the center of a search area quadrant.

4. The method of claim 2, wherein creating the first search area includes determining a maximum DC offset.

5. The method of claim 4, wherein creating the first search area includes creating a first step as a function of the maximum DC offset.

6. The method of claim 2, wherein creating the first search area includes creating a first unrotated search area.

7. The method of claim 2, wherein creating the first search area includes creating a first rotated search area.

8. The method of claim 1, wherein identifying the first optimum correction signal pair includes identifying a correction signal pair that yields the smallest output signal.

9. The method of claim 1, wherein applying the first optimum correction signal pair to the quadrature modulator for suppressing the carrier includes applying a first signal of the first optimum correction signal pair to an in-phase channel and applying a second signal of the first optimum correction signal pair to a quadrature-phase channel.

10. The method of claim 1, wherein suppressing the carrier includes performing a 2-dimensional binary search.

11. A program storage device, readable by a machine and tangibly embodying a representation of a program of instructions adapted to be executed by said machine to perform the method of claim 1.

12. The method of claim 1, further comprising:
sequentially applying a second set of four correction signal pairs to the quadrature modulator and detecting a second set of four output signals;
identifying a second optimum correction signal pair among the second set of four correction signal pairs; and
applying the second optimum correction signal pair to the quadrature modulator for suppressing the carrier.

13. The method of claim 12, further comprising creating a second search area, the second search area having a second set of four search area quadrants.

14. The method of claim 13, wherein the second search area is centered at the first optimum correction signal pair coordinates.

15. The method of claim 13, wherein creating the second search area includes creating a second step as a function of the first step.

16. The method of claim 15, wherein creating the second step as a function of the first step includes dividing the first step by a number greater than 1 and or lesser than or equal to 2.

17. The method of claim 13, wherein each of the second set of four correction signal pairs corresponds to the center of a second search area quadrant.

18. The method of claim 13, wherein creating the second search area includes creating a second unrotated search area.

19. The method of claim 13, wherein creating the second search area includes creating a second rotated search area.

20. The method of claim 12, wherein identifying the second optimum correction signal pair includes identifying a correction signal pair that yields the smallest output signal.

21. The method of claim 12, wherein applying the second optimum correction signal pair to the quadrature modulator for suppressing the carrier includes applying a first signal of the second optimum correction signal pair to an in-phase channel and applying a second signal of the second optimum correction signal pair to a quadrature-phase channel.

22. The method of claim 12, wherein suppressing the carrier includes performing a 2-dimensional binary search.

23. A program storage device, readable by a machine and tangibly embodying a representation of a program of instructions adapted to be executed by said machine to perform the method of claim 12.

24. An apparatus for suppressing a carrier in a quadrature modulator, comprising:
an amplifier;
a radio frequency detector coupled to the amplifier;
an analog-to-digital converter coupled to the radio frequency detector;
a correction circuit coupled to the analog-to-digital converter, the correction circuit performing a search algorithm during a training period and determining a pair of channel correction values for suppressing a carrier; and
a pair of summers coupled to the correction circuit.

25. The apparatus of claim 24, wherein the amplifier is coupled to an output of a quadrature modulator by a switch;

26. The apparatus of claim 24, wherein each of the pair of summers is coupled to a quadrature modulator channel.

27. The apparatus of claim 24, wherein the quadrature modulator includes a multi-modulator.

28. An integrated circuit for suppressing a carrier in a quadrature modulator comprising the apparatus of claim 24.
